(19) United States
(12) Patent Application Publication
(10) Pub. No.: US 2016/0226106 A1
(43) Pub. Date: Aug. 4, 2016

(54) METHOD FOR PRODUCING A NONAQUEOUS ELECTROLYTE SECONDARY BATTERY

(71) Applicant: Sanyo Electric Co., Ltd., Osaka (JP)

(72) Inventors: Keisuke Minami, Hyogo (JP); Toyoki Fujihara, Hyogo (JP); Naoya Nakanishi, Hyogo (JP)

(73) Assignee: Sanyo Electric Co., Ltd., Osaka (JP)

(21) Appl. No.: 15/007,430

(22) Filed: Jan. 27, 2016

(30) Foreign Application Priority Data
Jan. 29, 2015 (JP) 2015-016098

(51) Int. Cl. H01M 10/0587; H01M 10/04

(52) U.S. Cl. CPC H01M 10/0587; H01M 10/049; H01M 2300/0025

(57) ABSTRACT

A nonaqueous electrolyte secondary battery includes a flat wound electrode assembly and a ease that houses the wound electrode assembly and a nonaqueous electrolyte, the wound electrode assembly including a positive electrode plate, a negative electrode plate, and a separator, the positive electrode plate and the negative electrode plate being wound with the separator provided therebetween. The wound electrode assembly has a width-to-height ratio of 2 or more. The nonaqueous electrolyte contains lithium bis(oxalato)borate and lithium fluorosulfonate.

### CROSS REFERENCE TO RELATED APPLICATIONS:

The present invention application claims priority to Japanese Patent Application No. 2015-016098 filed in the Japan Patent Office on Jan. 29, 2015, the entire contents of which are incorporated herein by reference.

### BACKGROUND OF THE INVENTION

1. Field of the Invention

The present invention relates to a nonaqueous electrolyte secondary battery.

2. Description of Related Art

In recent years, nonaqueous electrolyte secondary batteries with high energy densities have been used for power sources for operation of electric vehicles (EVs) and hybrid electric vehicles (HEVs), such as plug-in hybrid electric vehicles (PHEVs). There is an increasing demand for higher performance of nonaqueous electrolyte secondary batteries used for such power sources for operation.

Japanese Published Unexamined Patent Application No. 2014-35952 (Patent Document 1) discloses a technique for adding lithium bis(oxalato)borate (LiBOB) to a nonaqueous electrolyte.

### BRIEF SUMMARY OF THE INVENTION

The addition of LiBOB to the nonaqueous electrolyte enables an increase in internal resistance to be inhibited.

Specifically, in the case where LiBOB is added to the nonaqueous electrolyte, a film originating from LiBOB is formed on a surface of a negative electrode at the time of initial charge or discharge, thereby inhibiting the increase in resistance due to charge-discharge cycles.

However, the inventors have advanced the development of batteries and have found that among various types of nonaqueous electrolyte secondary batteries containing LiBOB in their nonaqueous electrolytes, in a nonaqueous electrolyte secondary battery including a flat wound electrode assembly having a small height-to-width ratio, lithium is deposited in the middle portion of the negative electrode plate in the width direction, in some cases.

It is an object of the present invention to provide a nonaqueous electrolyte secondary battery including a flat wound electrode assembly having a small height-to-width ratio (in other words, a large width-to-height ratio), the deposition of lithium on a negative electrode plate being effectively inhibited even when LiBOB is added to a nonaqueous electrolyte, and to provide a method for producing the nonaqueous electrolyte secondary battery. In an embodiment of the present invention, it is possible to inhibit an increase in resistance due to charge-discharge cycles and inhibit the deposition of lithium and the occurrence of micro-short circuits through deposited lithium.

One aspect of the present invention provides a method for producing a nonaqueous electrolyte secondary battery, the nonaqueous electrolyte secondary battery including a flat wound electrode assembly, a nonaqueous electrolyte, and a case that houses the wound electrode assembly and the nonaqueous electrolyte, the wound electrode assembly including a positive electrode plate, a negative electrode plate, a separator, a wound positive-electrode-core-exposed portion at one end portion of the wound electrode assembly, and a wound negative-electrode-core-exposed portion at the other end portion of the wound electrode assembly, the positive electrode plate and the negative electrode plate being wound with the separator provided therebetween, the wound electrode assembly having a width-to-height ratio of 2 or more, and the method including a step of arranging the wound electrode assembly and the nonaqueous electrolyte in the case, the nonaqueous electrolyte containing lithium bis(oxalato)borate and lithium fluorosulfonate.

In an embodiment of the present invention, the wound electrode assembly preferably has a width-to-height ratio of 2.3 or more.

In another embodiment of the present invention, the negative electrode plate may have a substantially rectangular shape, a width of 100 to 140 mm, and a length of 2000 to 5000 mm.

Another aspect of the present invention provides a nonaqueous electrolyte secondary battery including a flat wound electrode assembly, a nonaqueous electrolyte, and a case that houses the wound electrode assembly and the nonaqueous electrolyte, the wound electrode assembly including a positive electrode plate, a negative electrode plate, a separator, a wound positive-electrode-core-exposed portion at one end portion of the wound electrode assembly, and a wound negative-electrode-core-exposed portion at the other end portion of the wound electrode assembly, the positive electrode plate and the negative electrode plate being wound with the separator provided therebetween, in which the wound electrode assembly has a width-to-height ratio of 2 or more, and the nonaqueous electrolyte contains lithium bis(oxalato)borate and lithium fluorosulfonate.

In an embodiment, of the present invention, the wound electrode assembly may have a width-to-height ratio of 2.3 or more.

In another embodiment of the present invention, the negative electrode plate may have a substantially rectangular shape, a width of 100 to 140 mm, and a length of 2000 to 5000 mm.

In yet another embodiment of the present invention, the separator preferably has a thickness of 15 to 25 μM and an air permeance of 150 to 500 s/100 cc, the negative electrode plate may have a negative electrode active material layer, and the negative electrode active material layer may have a packing density of 1.00 to 1.50 g/cc.

### BRIEF DESCRIPTION OF THE SEVERAL VIEWS OF THE DRAWINGS

FIG. 1 is a perspective view of a nonaqueous electrolyte secondary battery according to an embodiment

FIG. 2A is a cross-sectional view taken along line IIA-IIA in FIG. 1.

FIG. 2B is a cross-sectional view taken along line IIB-IIB in FIG. 2A.

FIG. 3A is a plan view of a positive electrode plate used for a nonaqueous electrolyte secondary battery according to an embodiment.

FIG. 3B is a cross-sectional view taken along line IIIB-IIIB in FIG. 3A.

FIG. 4A is a plan view of a negative electrode plate used for a nonaqueous electrolyte secondary battery according to an embodiment.

FIG. 4B is a cross-sectional view taken along line IVB-IVB in FIG. 4A.

### DETAILED DESCRIPTION OF THE INVENTION

While embodiments of the present invention will be described in detail below, the embodiments described below are merely illustrative, and the present invention is not limited to these embodiments.

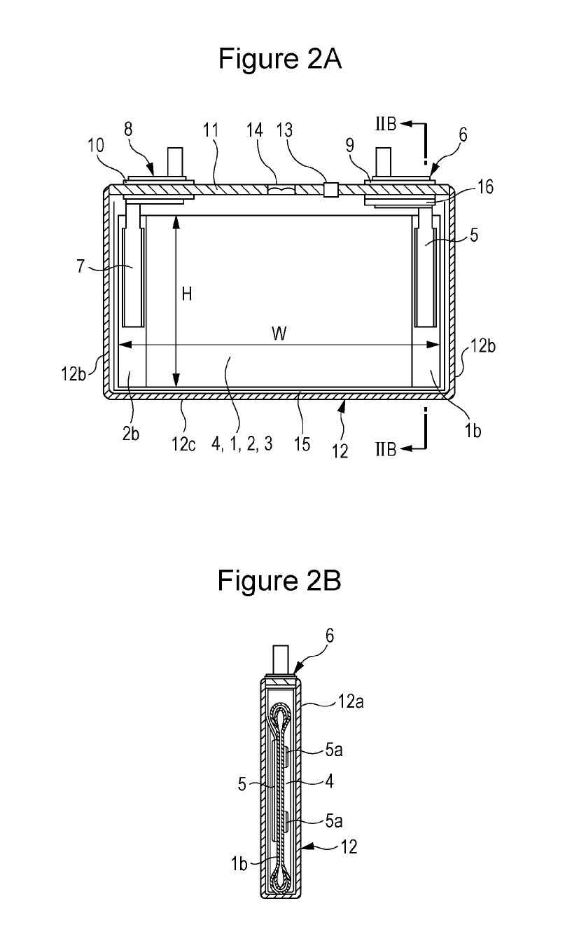

As illustrated in FIGS. 2A and 2B, a nonaqueous electrolyte secondary battery includes a flat wound electrode assembly 4 in which a positive electrode plate 1 and a negative electrode plate 2 are wound with a separator 3 provided therebetween. The outermost peripheral surface of the flat wound electrode assembly 4 is covered with the separator 3.

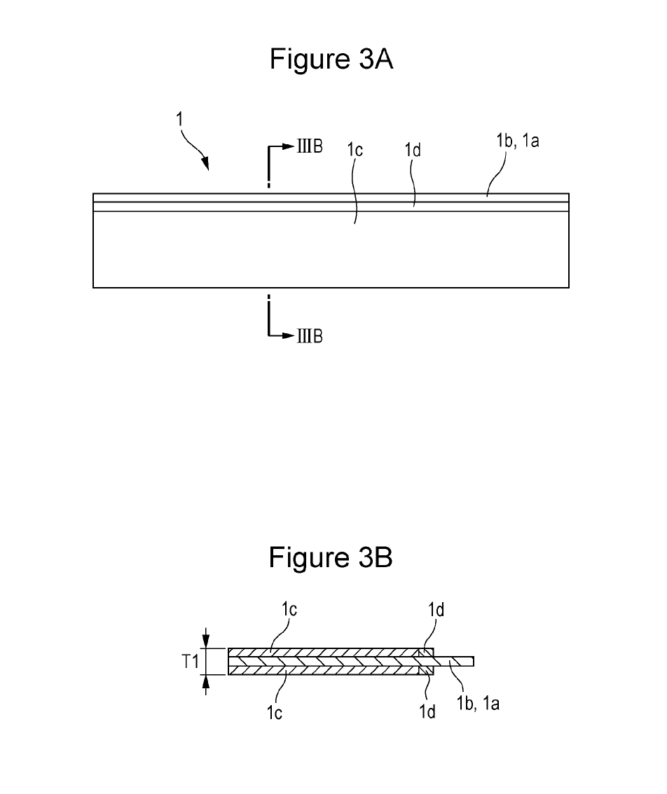

As illustrated in FIGS. 3A and 3B, the positive electrode plate 1 includes a positive electrode mixture layer 1c arranged on each of the surfaces of a positive electrode core 1a composed of aluminum or an aluminum alloy. A positive-electrode-core-exposed portion 1b of the positive electrode core 1a is arranged at an end portion of the positive electrode plate 1 in the width direction and exposed in a strip shape in the longitudinal direction. Positive electrode protective layers 1d are arranged on portions of the positive electrode core 1a in the vicinity of the end portions of the positive electrode mixture layers 1c. A structure without arranging the positive electrode protective layers 1d may also be used.

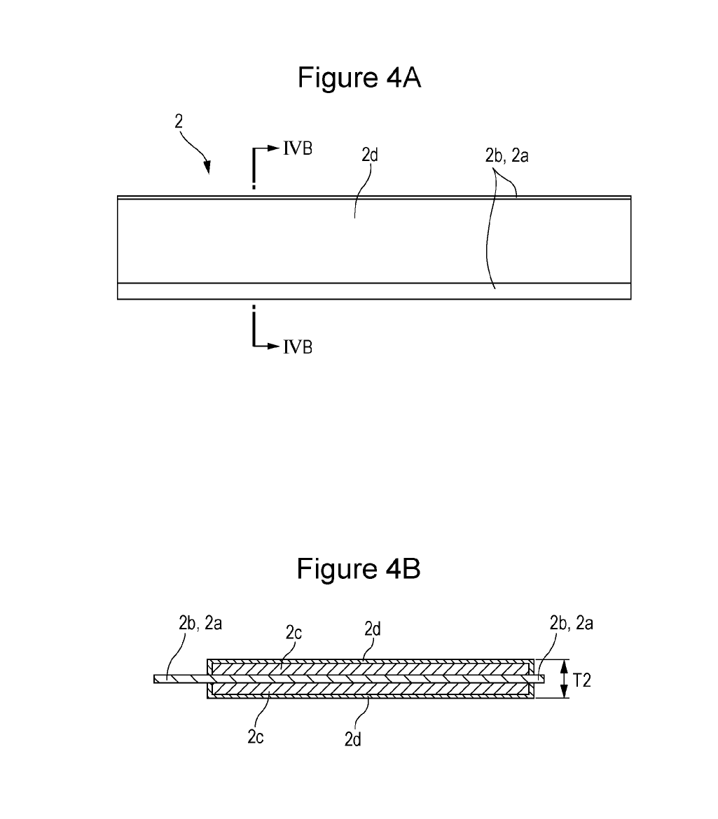

As illustrated in FIGS. 4A and 4B, the negative electrode plate 2 includes a negative electrode mixture layer 2c arranged on each of the surfaces of a negative electrode core 2a composed of copper or a copper alloy. A negative-electrode-core-exposed portion 2b of the negative electrode core 2a is arranged at each end portion of the negative electrode plate 2 in the width direction and exposed in a strip shape in the longitudinal direction. Negative electrode protective layers 2d are arranged on portions of the negative electrode mixture layers 2c. Here, the with of the negative-electrode-core-exposed portion 2b arranged at one end portion of the negative electrode plate 2 in the width direction is larger than that of the negative-electrode-core-exposed portion 2b arranged at the other end portion of the negative electrode plate 2 in the width direction. The negative-electrode-core-exposed portion 2b may be arranged at only one of the end portions of the negative electrode plate 2 in the width direction. A structure without arranging the negative electrode protective layers 2d may be used.

The positive electrode plate 1 and the negative electrode plate 2 are wound with the separator 3 provided therebetween to form a flat article, thereby producing the flat wound electrode assembly 4. At this time, the wound positive-electrode-core-exposed portion 1b is formed at one end portion of the flat wound electrode assembly 4. The wound negative-electrode-core-exposed portion 2b is formed at the other end.

As illustrated in FIGS. 2A and 2B, the wound positive-electrode-core-exposed portion 1b is electrically connected to a positive electrode terminal 6 through a positive electrode current collector 5. The wound negative-electrode-core-exposed portion 2b is electrically connected to a negative electrode terminal 8 through a negative electrode current collector 7. The positive electrode current collector 5 and the positive electrode terminal 6 are preferably composed of aluminum or an aluminum alloy. The negative electrode current collector 7 and the negative electrode terminal 8 are preferably composed of copper or a copper alloy. The positive electrode terminal 6 preferably includes a connecting portion 6a passing through a sealing member 11 composed of a metal, a plate-shaped portion 6b arranged outside the sealing member 11, and a bolt portion 6c arranged on the plate-shaped portion 6b. The negative electrode terminal 8 preferably includes a connecting portion 8a passing through the sealing member 11, a plate-shaped portion 8b arranged outside the sealing member 11, and a bolt portion 8c arranged on the plate-shaped portion 8b.

A current blocking mechanism 16 is arranged in a conduction path between the positive electrode plate 1 and the positive electrode terminal 6. The current blocking mechanism 16 operates when the internal pressure of the battery exceeds a predetermined value, thereby blocking the conduction path between the positive electrode plate 1 and the positive electrode terminal 6.

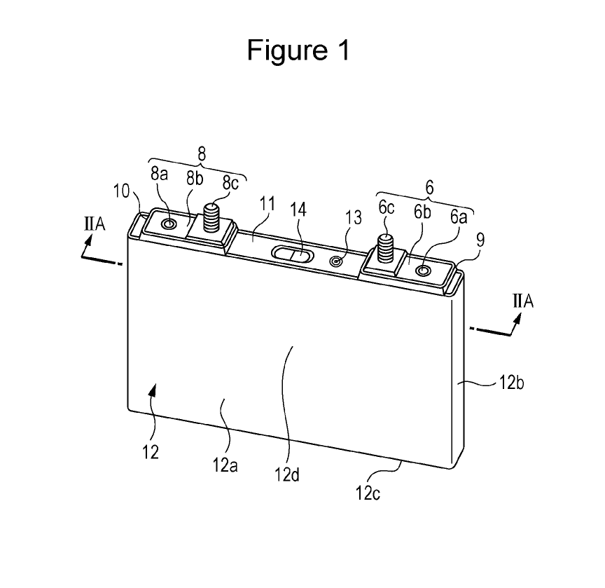

As illustrated in FIGS. 1 and 2A, the positive electrode terminal 6 is fixed to the sealing member 11 with an insulating member 9 provided therebetween. The negative electrode terminal 8 is fixed to the sealing member 11 with an insulating member 10.

The flat wound electrode assembly 4 is housed in a prismatic case 12 while being covered with an insulating sheet 15 composed of a resin. The sealing member 11 is in contact with an opening portion of the prismatic case 12 composed of a metal. A contact portion between the sealing member 11 and the prismatic case 12 is laser-welded.

The prismatic case 12 has a polygonal-tube structure with as closed bottom and as pair of large-area side walls 12a, a, pair of small-area side walls 12b having a smaller area than that of the large-area side walls 12a, and a bottom portion 12c. Flat portions of the flat wound electrode assembly 4 are arranged in such a manner that a pair of flat outer surfaces faces the pair of large-area side walls 12a.

The-sealing member 11 has an electrolytic solution inlet 13. A nonaqueous electrolytic solution is injected through the electrolytic solution inlet 13. The electrolytic solution inlet 13 is then sealed with, for example, a blind rivet. A gas relief valve 14 is arranged in the sealing member 11. When the internal pressure of the battery exceeds the operating pressure of the current blocking mechanism 16, the gas relief valve 14 is broken to release a gas generated in the battery into the outside of the battery. A structure without arranging the current blocking mechanism 16 may be used.

Methods for producing the positive electrode plate 1, the negative electrode plate 2, the flat wound electrode assembly 4, and a nonaqueous electrolytic solution serving as a nonaqueous electrolyte in the nonaqueous electrolyte secondary battery will be described below.

### Production of Positive Electrode Plate

A lithium transition metal composite oxide represented by Li(Ni_{0.35}Co_{0.35}Mn_{0.30})_{0.95}Zr_{0.05}O₂ is used as a positive electrode active material. The positive electrode active material, a carbon powder serving as a conductive agent, and polyvinylidene fluoride (PVdF) serving as a binder are weighed in a mass ratio of 91:7:2 and mixed with N-methyl-2-pyrrolidone (NMP) serving as a dispersion medium to prepare a positive electrode mixture slurry.

An alumina powder, PVdF, a carbon powder, and NMP serving as a dispersion medium are mixed together in a mass ratio of 21:4:1:74 to prepare a positive electrode protective layer slurry.

The positive electrode mixture slurry prepared by the foregoing method is applied to both surfaces of aluminum foil serving as the positive electrode core 1a with a die coater. The positive electrode protective layer slurry prepared by the foregoing method is applied to portions of the positive electrode core 1a adjacent to end portions of regions to which the positive electrode mixture slurry has been applied. The electrode plate is dried to remove NMP serving as a dispersion medium. The resulting article is compressed with a roll press so as to have a predetermined thickness. The article is cut into predetermined dimensions in such a manner that the positive-electrode-core-exposed portion 1b where the positive electrode mixture layer 1c is not arranged on each surface is formed at an end portion of the positive electrode plate 1 in the width direction and exposed in the longitudinal direction, thereby producing the positive electrode plate 1.

### Production of Negative Electrode Plate

A carbon powder serving as a negative electrode active material, carboxymethylcellulose (CMC) serving as a thickener, and styrene-butadiene rubber (SBR) serving as a binder are dispersed in water in a mass ratio of 98:1:1 to prepare a negative electrode mixture slurry.

An alumina powder, a binder (acrylic-based resin), and NMP serving as a dispersion medium are mixed together in a mass ratio of 30:0.9:69.1. The mixture is subjected to mixing and dispersion treatment with a bead mill, thereby preparing a negative electrode protective layer slurry.

The negative electrode mixture slurry prepared by the foregoing method is applied to both surfaces of copper foil serving as the negative electrode core 2a and dried to remove water serving as a dispersion medium. The resulting article is compressed with a roll press so as to have a predetermined thickness. The negative electrode protective layer slurry prepared by the foregoing method is applied to the negative electrode mixture layers 2c. NMP used as a dispersion medium is removed by drying to form the negative electrode protective layers 2d. The article is cut into predetermined dimensions in such a manner that the negative-electrode-core-exposed portions 2b where none of the negative electrode mixture layers 2c is arranged on each surface are formed at both end portions of the negative electrode plate in the width direction and exposed in the longitudinal direction, thereby producing the negative electrode plate 2.

### Production of Flat Wound Electrode Assembly

The positive electrode plate 1 and the negative electrode plate 2 produced by the foregoing methods are wound with the separator 3 provided therebetween, the separator 3 being composed of polypropylene and having a thickness of 20 μm. The resulting article is pressed into a flat shape, thereby producing the flat wound electrode assembly 4. At this time, the wound positive-electrode-core-exposed portion 1b is formed at one end portion of the flat wound electrode assembly 4 in the direction of the winding axis. Simultaneously, one of the negative-electrode-core-exposed portions 2b is formed at the other end portion. The separator 3 is located at the outermost peripheral surface of the flat wound electrode assembly 4. The end winding portion of the wound negative electrode plate 2 is located at an outward position with respect to the end winding portion of the wound positive electrode plate 1.

In the flat wound electrode assembly 4, the positive electrode mixture layer has a packing density of, for example, 2.47 g/cm³, and the negative electrode mixture layer has a packing density of, for example, 1.13 g/cm³.

### Preparation of Nonaqueous Electrolytic Solution

Ethylene carbonate (EC), ethyl methyl carbonate (EMC), and diethyl carbonate (DEC) are mixed together in a volume ratio of 3:3:4 (25° C. 1 atm) to prepare a solvent mixture. LiPF₆ serving as a solute is added to the solvent mixture to a concentration of 1 mol/L. Predetermined amounts of LiBOB and lithium fluorosulfonate are added thereto. These additives will be described in more detail by examples.

### Assembly of Nonaqueous Electrolyte Secondary Battery

The positive electrode terminal 6 and the positive electrode current collector 5 are fixed to the sealing member 11 composed of aluminum with the insulating member 9 provided therebetween with the positive electrode terminal 6 electrically connected to the positive electrode current collector 5. The current blocking mechanism 16 in which the conduction path between the positive electrode terminal 6 and the positive electrode current collector 5 is blocked when the internal pressure of the battery is increased is arranged between the positive electrode terminal 6 and the positive electrode current collector 5. The negative electrode terminal 8 and the negative electrode current collector 7 are fixed to the sealing member 11 with the insulating member 10 provided therebetween with the negative electrode terminal 8 electrically connected to the negative electrode current collector 7. The positive electrode current collector 5 and mounting components 5a are connected to the outermost peripheral surface of the wound positive-electrode-core-exposed portion 1b. The negative electrode current collector 7 and the mounting components are connected to the outermost peripheral surface of the negative-electrode-core-exposed portion 2b.

The flat wound electrode assembly 4 is covered with the insulating sheet 15 which is composed of polypropylene and which has been formed by bending into a box shape. The resulting article is inserted into the prismatic case 12 composed of aluminum. The contact portion between the prismatic case 12 and the sealing member 11 is laser-welded to seal the opening portion of the prismatic case 12.

The nonaqueous electrolytic solution prepared by the foregoing method is injected through the electrolytic solution inlet 13 of the sealing member 11. The electrolytic solution inlet 13 is sealed with a blind rivet to produce the nonaqueous electrolyte secondary battery.

As described above, in the case where LiBOB is added to the nonaqueous electrolyte, a film originating from LiBOB is formed on a surface of a negative electrode at the time of initial charge or discharge, thereby inhibiting the increase in resistance due to charge-discharge cycles.

However, in a nonaqueous electrolyte secondary battery including a LiBOB-containing nonaqueous electrolyte and a flat wound electrode assembly having a small height with respect to its width, lithium is deposited in the middle portion of a negative electrode plate in the width direction, in some cases. In other words, in the nonaqueous electrolyte secondary battery including a flat wound electrode assembly having a small height with respect to its width, the nonaqueous electrolyte does not easily penetrate the middle portion the width direction. Thus, the film originating from LiBOB is less likely to be formed in the middle portion in the width direction. Although the film originating from LiBOB inhibits an increase in resistance due to charge-discharge cycles, a region where the amount of the film originating from LiBOB large has a slightly higher resistance than that of a region where the amount of the film originating from LiBOB is small. A region where the film is not easily formed has a lower resistance than that of another region, so that a current concentrates easily in the region, thereby easily depositing lithium in the region. The inventors have found that lithium is easily deposited in the middle portion in the width direction when charging and discharging are performed, in particular, in a low-temperature state. The amount of LiBOB added is preferably in the range of 0.01 M to 0.15 M and more preferably 0.03 M to 0.12 M with respect to the total amount of the nonaqueous electrolyte. The amount of lithium fluorosulfonate is preferably in the range of 0.1% to 4.0% by weight and more preferably 0.5% to 2.0% by weight with respect to the total amount of the nonaqueous electrolyte.

In the embodiments, lithium fluorosulfonate is added as a nonaqueous electrolyte in addition to LiBOB as described above. The addition of lithium fluorosulfonate suppresses variations in the formation state of the film originating from LiBOB to form the substantially uniform film originating from LiBOB in the middle portion in the width direction, thereby inhibiting the deposition of lithium.

Examples will be described below.

### EXAMPLES

### Example 1

A nonaqueous electrolyte secondary battery was produced in the same way as above under conditions described below.
Height of wound electrode assembly: 54.3 mm
Width of wound electrode assembly: 134 mm
Width-to-height ratio, i.e., width/height, of wound electrode assembly: 2.47
Length of negative electrode plate: 3585 mm
Width of negative electrode plate: 121.8 mm
Length of positive electrode plate: 3500 mm
Width of positive electrode plate: 119.8 mm

Here, the width of the wound electrode assembly indicates a length of the wound electrode assembly in a direction along the extension of the winding axis of the wound electrode assembly in plan view of the wound electrode assembly, the length including core exposed portions at both ends. The height of the wound electrode assembly indicates a length of the wound electrode assembly in a direction (direction perpendicular to the sealing member 11) perpendicular to a direction along the extension of the winding axis of the wound electrode assembly in plan view of the wound electrode assembly. For example, the width of the wound electrode assembly is represented by length W in FIG. 2A. The height of the wound electrode assembly is represented by H in FIG. 2A.

A nonaqueous electrolyte was prepared as follows: Ethylene carbonate (EC), ethyl methyl carbonate (EMC), and diethyl carbonate (DEC) were mixed together in a volume ratio of 3:3:4 (25° C., 1 atm) to prepare a solvent mixture. LiPF₆ serving as a solute was added to the solvent mixture to a concentration of 1 mol/L. Furthermore, LiBOB was added thereto to a concentration of 0.05 M. Moreover, lithium fluorosulfonate was added thereto to a concentration of 1% by weight.

### Comparative Example 1

A nonaqueous electrolyte secondary battery was produced as in Example 1, except that the nonaqueous electrolyte was prepared as follows: Ethylene carbonate (EC), ethyl methyl carbonate (EMC), and diethyl carbonate (DEC) were mixed together in a volume ratio of 3:3:4 (25° C., 1 atm) to prepare a solvent mixture. LiPF6 serving as a solute was added to the solvent mixture to a concentration of 1 mol/L. Furthermore, LiBOB was added thereto to a concentration of 0.05 M. Lithium fluorosulfonate was not added thereto.

### Comparative Example 2

A nonaqueous electrolyte secondary battery was produced as in Example 1, except that the conditions were changed as described below.
Height of wound electrode assembly: 82.1 mm
Width of wound electrode assembly: 143.8 mm
Width-to-height ratio, i.e., width/height, of wound electrode assembly: 1.75
Length of negative electrode plate: 6695 mm
Width of negative electrode plate: 133.8 mm
Length of positive electrode plate: 6525 mm
Width of positive electrode plate: 131.8 mm

Furthermore, the nonaqueous electrolyte was prepared as follows: Ethylene carbonate (EC), ethyl methyl carbonate (EMC), and diethyl carbonate (DEC) were mixed together in a volume ratio of 3:3:4 (25° C., 1 atm) to prepare a solvent mixture. LiPF6 serving as a solute was added to the solvent mixture to a concentration of 1 mol/L. Moreover, LiBOB was added thereto to a concentration of 0.05 M. Lithium fluorosulfonate was not added thereto.

The nonaqueous electrolyte secondary batteries were produced as described above. Each of the nonaqueous electrolyte secondary batteries was charged to a state of charge (SOC) of 80% at 25° C. A charge-discharge cycle operation in which charging and discharging were each performed for 20 seconds at a constant current of 15 C and a temperature of −10° C. was repeated 1000 times. Each nonaqueous electrolyte secondary battery was disassembled. The presence or absence of the deposition of lithium on the negative electrode plate was visually checked. The test results were described below.

TABLE 1

| | Width/ | | Deposition |
|---|---|---|---|
| | height | Nonaqueous electrolyte | of lithium |
| Example 1 | 2.47 | LiBOB + lithium | no |
| | | fluorosulfonate | |
| Comparative | 2.47 | LiBOB (without lithium | yes |
| example 1 | | fluorosulfonate) | |
| Comparative | 1.75 | LiBOB (without lithium | no |
| example 2 | | fluorosulfonate) | |

A comparison of Example 1 with Comparative example 1 reveals that the addition of LiBOB and lithium fluorosulfonate to the nonaqueous electrolyte suppresses the deposition of lithium. A comparison of Example 1 with Comparative example 2 reveals that in Comparative example 2, in the case where lithium fluorosulfonate is not added, when the width-to-height ratio is small, i.e., the width/height of the wound electrode assembly =1.751, lithium is not deposited. Accordingly, in the wound electrode assembly having a width-to-height ratio, i.e., width/height, of a predetermined value or more, specifically, 2 or more, the addition of LiBOB and lithium fluorosulfonate to the nonaqueous electrolyte is effective. In the case where the width-to-height ratio, i.e., width/height, of the wound electrode assembly is 2.3 or more, the addition of LiBOB and lithium fluorosulfonate to the nonaqueous electrolyte is particularly effective.

In the case where the negative electrode plate has a not-so-large area, the effect of the embodiments is significantly large because a current value per unit area is large, so that lithium is easily deposited. Thus, the addition of LiBOB and lithium fluorosulfonate to the nonaqueous electrolyte is effective within a predetermined range of the area of the negative electrode plate. For example, in the case where the negative electrode plate has a width of 100 mm to 140 mm and a length of 2000 mm to 5000 mm, LiBOB and lithium fluorosulfonate are preferably added to the nonaqueous electrolyte.

Furthermore, in the case where the separator has a thickness of 15 μm to 25 μm and an air permeance of 150 to 500 s/100 cc and where the negative electrode active material layer has a packing density of 1.00 to 1.50 g/cc, LiBOB and lithium fluorosulfonate are preferably added to the nonaqueous electrolyte.

The width-to-height ratio of the wound electrode assembly is preferably 2 or more and more preferably 2.3 or more. Furthermore, the width-to-height ratio of the wound electrode assembly is preferably 4 or less.

The wound electrode assembly preferably has a height of 3 cm to 10 cm and a width of 6 cm to 20 cm.

The thickness of the wound electrode assembly (i.e., a length of the wound electrode assembly in a direction perpendicular to the direction of extension of the winding axis, the length being in a direction perpendicular to the height direction) is not particularly limited and is preferably in the range of 5 to 30 mm, more preferably 8 to 25 mm, and still more preferably 8 to 20 mm.

While the embodiments of the present invention have been described above, the present invention is not limited to these embodiments. Various changes can be made.

For example, in the embodiments, the nonaqueous electrolytic solution is injected into the case after the insertion of the wound electrode assembly into the case. However, the wound electrode assembly may be inserted into the case after the injection of the nonaqueous electrolytic solution into the case.

In the embodiments, LiBOB and lithium fluorosulfonate are added to the nonaqueous electrolyte. The formation of the film composed of LiBOB on the surfaces of the negative electrode plate due to charging and discharging may lead to the absence of LiBOB in the nonaqueous electrolyte. It will be obvious that this case is also included in the technical scope of the present invention. Also in this case, the nonaqueous electrolyte containing LiBOB and lithium fluorosulfonate is arranged in the case.

Examples of the positive electrode active material include lithium transition metal composite oxides, such as lithium cobalt oxide (LiCoO₂), lithium manganese oxide (LiMn₂O₄), lithium nickel oxide (LiNiO₂), lithium nickel manganese composite oxide (LiNi₁₋ₓMnₓO₂ (0<x<1)), lithium nickel cobalt composite oxide (LiNi₁₋ₓCoₓO₂ (0<x<1)), and lithium nickel cobalt manganese composite oxide (LiNiₓCo_{y}Mn₂O₂ (0<x<1, 0<y<1, 0<z<1, and x+y+z=1)). Furthermore, compounds in which Al, Ti, Zr, Nb, B, W, Mg, Mo, or the like is added to the foregoing lithium transition metal composite oxides may also be used. Examples thereof include lithium transition metal composite oxides represented by Li₁₊ₐNiₓCo_{y}Mn_{z}M_{b}O₂ (wherein M represents at least one element selected from Al, Ti, Zr, Nb, B, Mg, and Mo, 0≦a≦0.2, 0.2≦x≦0.5, 0.2≦y≦0.5, 0.2≦z≦0.4, 0≦b≦0.02, and a+b+x+y+z=1).

A carbon material capable of occluding and releasing lithium ions, may be used as the negative electrode active material. Examples of the carbon material capable of occluding and releasing lithium ions include graphite, non-graphitizable carbon, graphitizable carbon, fibrous carbon, coke, and carbon black. Of these, graphite is particularly preferred. Examples of a non-carbon material include silicon, tin, alloys, and oxides mainly containing silicon and/or tin.

As a nonaqueous solvent (organic solvent) for the nonaqueous electrolyte, carbonates, lactones, ethers, ketones, esters, and so forth may be used. These solvents may be used in combination as a mixture of two or more thereof. Specific examples of the solvent that may be used include cyclic carbonates, such as ethylene carbonate, propylene carbonate, and butylene carbonate; and chain carbonates, such as dimethyl carbonate, ethyl methyl carbonate, and diethyl carbonate. In particular, a solvent mixture of a cyclic carbonate and a chain carbonate is preferably used. Furthermore, an unsaturated cyclic carbonate, such as vinylene carbonate (VC), may be added to the nonaqueous electrolyte.

As an electrolyte salt for the nonaqueous electrolyte, electrolyte salts commonly used for lithium-ion secondary batteries in the related art may be used. Examples of the electrolyte salt that may be used include LiBF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, LiP(C₂O₄)F₄, and mixtures thereof. Of these, LiPF₆ is particularly preferred. The amount of the electrolyte salt dissolved in the nonaqueous solvent is preferably in the range of 0.5 to 2.0 mol/L.

As the separator, a porous separator composed of polyolefin, for example, polypropylene (PP) or polyethylene (PE), is preferably used. In particular, a separator having a three-layer structure composed of polypropylene (PP) and polyethylene (PE) (i.e., PP/PE/PP or PE/PP/PE) is preferably used. Furthermore, a polyelectrolyte may be used as a separator.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

A ratio of a total mass of the nonaqueous electrolyte included in the nonaqueous electrolyte secondary battery to a total mass of the negative electrode active material included in the nonaqueous electrolyte secondary battery (the total mass of the nonaqueous electrolyte included in the nonaqueous electrolyte secondary battery (g)/the total mass of the negative electrode active material included in the nonaqueous electrolyte secondary battery g)) is preferably 1.8 to 2.2.

The ratio of the total mass of the nonaqueous electrolyte included in the nonaqueous electrolyte secondary battery to the total mass of the negative electrode active material included in the nonaqueous electrolyte secondary battery (the total mass of the nonaqueous electrolyte included in the nonaqueous electrolyte secondary battery (g)/the total mass of the negative electrode active material included in the nonaqueous electrolyte secondary battery (g)) is more preferably 1.9 to 2.1.

A ratio of a total mass of the nonaqueous electrolyte included in the nonaqueous electrolyte secondary battery to a total mass of the positive electrode active material included in the nonaqueous electrolyte secondary battery (the total mass of the nonaqueous electrolyte included in the nonaqueous electrolyte secondary battery (g)/the total mass of the positive electrode active material included in the nonaqueous electrolyte secondary battery (g)) is preferably 0.9 to 1.3.

The ratio of the total mass of the nonaqueous electrolyte included in the nonaqueous electrolyte secondary battery to the total mass of the positive electrode active material included in the nonaqueous electrolyte secondary battery (the total mass of the nonaqueous electrolyte included in the nonaqueous electrolyte secondary battery (g)/the total mass of the positive electrode active material included in the nonaqueous electrolyte secondary battery (g)) is more preferably 1.0 to 1.2.

What is claimed is:

1. A method for producing a nonaqueous electrolyte secondary battery, the nonaqueous electrolyte secondary battery including
a flat wound electrode assembly,
a nonaqueous electrolyte, and
a case that houses the wound electrode assembly and the nonaqueous electrolyte,
the wound electrode assembly including
a positive electrode plate,
a negative electrode plate,
a separator,
a wound positive-electrode-core-exposed portion at one end portion of the wound electrode assembly, and
a wound negative-electrode-core-exposed portion at the other end portion of the wound electrode assembly, the positive electrode plate and the negative electrode plate being wound with the separator provided therebetween,
the wound electrode assembly having a width-to-height ratio of 2 or more, and
the method comprising a step of:
arranging the wound electrode assembly and the nonaqueous electrolyte in the case, the nonaqueous electrolyte containing lithium bis(oxalato)borate and lithium fluorosulfonate.

2. The method according to claim 1,
wherein the wound electrode assembly has a width-to-height ratio of 2.3 or more.

3. The method according to claim 1,
wherein the negative electrode plate has a substantially rectangular shape, a width of 100 to 140 mm, and a length of 2000 to 5000 mm.

4. The method according to claim 1,
wherein the separator has a thickness of 15 to 25 μm and an air permeance of 150 to 500 s/100 cc,
the negative electrode plate has a negative electrode active material layer, and
the negative electrode active material layer has a packing density of 1.00 to 1.50 g/cc.

5. The method according to claim 1,
wherein a ratio of a total mass of the nonaqueous electrolyte included in the nonaqueous electrolyte secondary battery to a total mass of a negative electrode active material included in the nonaqueous electrolyte secondary battery is 1.8 to 2.2.

6. The method according to claim 1,
wherein a ratio of a total mass of the nonaqueous electrolyte included in the nonaqueous electrolyte secondary battery to a total mass of a positive electrode active material included in the nonaqueous electrolyte secondary battery is 0.9 to 1.3.

7. A method for producing a nonaqueous electrolyte secondary battery, the nonaqueous electrolyte secondary battery including
a flat wound electrode assembly,
nonaqueous electrolyte, and
a case that houses the wound electrode assembly and the nonaqueous electrolyte,
the wound electrode assembly including
a positive electrode plate,
a negative electrode plate,
a separator,
a wound positive-electrode-core-exposed portion at one end portion of the wound electrode assembly, and
a wound negative-electrode-core-exposed portion at the other end portion of the wound electrode assembly, the positive electrode plate and the negative electrode plate being wound with the separator provided therebetween,
the wound electrode assembly having a width-to-height ratio of 2 or more, and
the method comprising a step of:
arranging the nonaqueous electrolyte in the case, the nonaqueous electrolyte containing lithium bis(oxalato)borate and lithium fluorosulfonate.

8. The method according to claim 7,
wherein the wound electrode assembly has a width-to-height ratio of 2.3 or more.

9. The method according to claim 7,
wherein the negative electrode plate has a substantially rectangular shape, a width of 100 to 140 mm, and a length of 2000 to 5000 mm.

10. The method according to claim 7,
wherein the separator has a thickness of 15 to 25 μm and an air permeance of 150 to 500 s/100 cc,
the negative electrode plate has a negative electrode active material layer, and
the negative electrode active material layer has a packing density of 1.00 to 1.50 g/cc.

11. The method according to claim 7,
wherein a ratio of a total mass of the nonaqueous electrolyte included in the nonaqueous electrolyte secondary battery to a total mass of a negative electrode active material included in the nonaqueous electrolyte secondary battery is 1.8 to 2.2.

12. The method according to claim 7,
wherein a ratio of a total mass of the nonaqueous electrolyte included in the nonaqueous electrolyte secondary battery to a total mass of a positive electrode active material included in the nonaqueous electrolyte secondary battery is 0.9 to 1.3.
